(19) United States
(12) Patent Application Publication
(10) Pub. No.: US 2026/0039874 A1
(43) Pub. Date: Feb. 5, 2026

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Yingzhan XU, Beijing (CN); Jai ZHABG, Los Angeles, CA (US); Li ZHANG, Los Angeles, CA (US)

(21) Appl. No.: 19/356,756

(22) Filed: Oct. 13, 2025

Related U.S. Application Data
(63) Continuation of application No. PCT/CN2024/087627, filed on Apr. 12, 2024.

(30) Foreign Application Priority Data
Apr. 13, 2023 (CN) PCCN2023/088230

(51) Int. Cl. H04N 19/597; H04N 19/132; H04N 19/136; H04N 19/172; H04N 19/503

(52) U.S. Cl. CPC H04N 19/597; H04N 19/132; H04N 19/136; H04N 19/172; H04N 19/503

(57) ABSTRACT

Embodiments of the present disclosure provide a method for point cloud coding. In the method, a conversion between a current frame of a point cloud sequence and a bitstream of the point cloud sequence is performed. A reference frame is updated based on the conversion. The reference frame is to be used for a further conversion between at least one subsequent frame of the point cloud sequence and the bitstream of the point cloud sequence.

### CROSS REFERENCE TO RELATED APPLICATIONS

This application is a continuation of International Application No. PCT/CN2024/087627, filed on Apr. 12, 2024, which claims the benefit of International Application No. PCT/CN2023/088230 filed on Apr. 13, 2023. The entire contents of these applications are hereby incorporated by reference in their entireties.

### FIELDS

Embodiments of the present disclosure relate generally to point cloud coding techniques, and more particularly, to reference frame updating.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: performing a conversion between a current frame of a point cloud sequence and a bitstream of the point cloud sequence; and updating a reference frame based on the conversion, the reference frame to be used for a further conversion between at least one subsequent frame of the point cloud sequence and the bitstream of the point cloud sequence. The method in accordance with the first aspect of the present disclosure updates the reference frame used for coding subsequent frames in the point cloud sequence, and thus can improve the coding effectiveness and coding efficiency.

In a second aspect, another method for point cloud coding is proposed. The method comprises: determining, for a conversion between a current frame of a point cloud sequence and a bitstream of the point cloud sequence, a reference frame for the current frame; determining, from the reference frame, a reference point cloud (PC) sample of a current PC sample in the current frame before an inter prediction of the current PC sample; and performing the conversion based on the reference PC sample. The method in accordance with the second aspect of the present disclosure determines the reference PC sample before the inter prediction of the current PC sample, and thus can improve the attribute coding.

In a third aspect, another method for point cloud coding is proposed. The method comprises: performing, for a conversion between a current frame of a point cloud sequence and a bitstream of the point cloud sequence, a neighbor search of an attribute inter prediction of the current frame; and performing the conversion based on the neighbor search, wherein an attribute inter search range for the neighbor search of the attribute inter prediction is included in the bitstream based on a condition. The method in accordance with the third aspect of the present disclosure indicates the attribute inter search range in the bitstream conditionally, and thus can improve the attribute coding.

In a fourth aspect, an apparatus for processing point cloud sequence is proposed. The apparatus for processing point cloud sequence comprises a processor and a non-transitory memory with instructions thereon. The instructions upon execution by the processor, cause the processor to perform a method in accordance with the first aspect, the second aspect or the third aspect of the present disclosure.

In a fifth aspect, a non-transitory computer-readable storage medium is proposed. The non-transitory computer-readable storage medium stores instructions that cause a processor to perform a method in accordance with the first aspect, the second aspect or the third aspect of the present disclosure.

In a sixth aspect, a non-transitory computer-readable recording medium is proposed. The non-transitory computer-readable recording medium stores a bitstream of a point cloud sequence which is generated by a method performed by a point cloud processing apparatus. The method comprises: generating the bitstream based on a current frame of the point cloud sequence; and updating a reference frame based on the current frame, the reference frame to be used for at least one subsequent frame of the point cloud sequence.

In a seventh aspect, a method for storing a bitstream of a point cloud sequence is proposed. The method comprises: generating the bitstream based on a current frame of the point cloud sequence; updating a reference frame based on the current frame, the reference frame to be used for at least one subsequent frame of the point cloud sequence; and storing the bitstream in a non-transitory computer-readable recording medium.

In an eighth aspect, a non-transitory computer-readable recording medium is proposed. The non-transitory computer-readable recording medium stores a bitstream of a point cloud sequence which is generated by a method performed by a point cloud processing apparatus. The method comprises: determining a reference frame for a current frame of the point cloud sequence; determining, from the reference frame, a reference point cloud (PC) sample of a current PC sample in the current frame before an inter prediction of the current PC sample; and generating the bitstream based on the reference PC sample.

In a ninth aspect, a method for storing a bitstream of a point cloud sequence is proposed. The method comprises: determining a reference frame for a current frame of the point cloud sequence; determining, from the reference frame, a reference point cloud (PC) sample of a current PC sample in the current frame before an inter prediction of the current PC sample; generating the bitstream based on the reference PC sample; and storing the bitstream in a non-transitory computer-readable recording medium.

In a tenth aspect, a non-transitory computer-readable recording medium is proposed. The non-transitory computer-readable recording medium stores a bitstream of a point cloud sequence which is generated by a method performed by a point cloud processing apparatus. The method comprises: performing a neighbor search of an attribute inter prediction of a current frame of the point cloud sequence; and generating the bitstream based on the neighbor search, wherein an attribute inter search range for the neighbor search of the attribute inter prediction is included in the bitstream based on a condition.

In an eleventh aspect, a method for storing a bitstream of a point cloud sequence is proposed. The method comprises: performing a neighbor search of an attribute inter prediction of a current frame of the point cloud sequence; generating the bitstream based on the neighbor search; and storing the bitstream in a non-transitory computer-readable recording medium, wherein an attribute inter search range for the neighbor search of the attribute inter prediction is included in the bitstream based on a condition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder in accordance with some embodiments of the present disclosure;

FIG. 3 illustrates a block diagram that illustrates an example point cloud decoder in accordance with some embodiments of the present disclosure;

FIG. 4 illustrates a flowchart of the compression process of one frame with updating the reference frame in accordance with embodiments of the present disclosure;

FIG. 5 illustrates a flowchart of a method for point cloud coding in accordance with embodiments of the present disclosure;

FIG. 6 illustrates another flowchart of a method for point cloud coding in accordance with embodiments of the present disclosure;

FIG. 7 illustrates another flowchart of a method for point cloud coding in accordance with embodiments of the present disclosure; and

FIG. 8 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

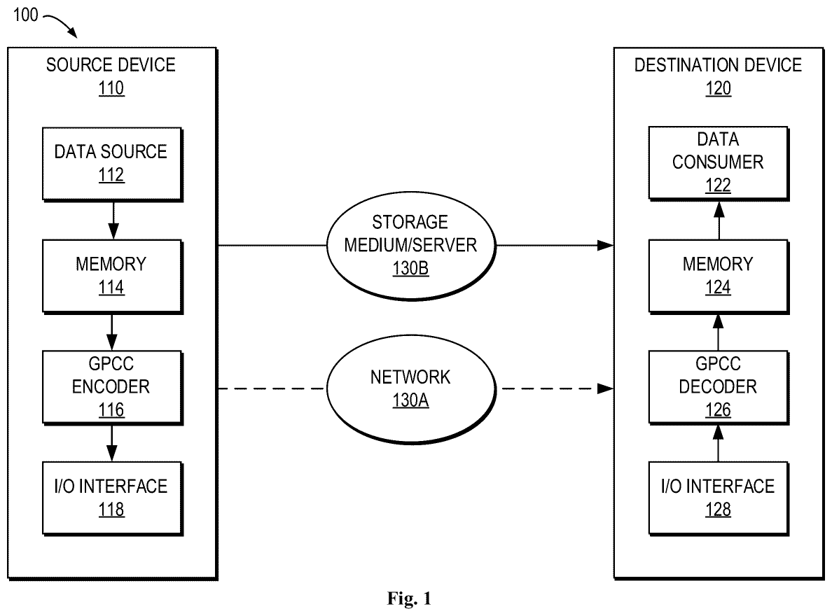

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data.

For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like.

In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

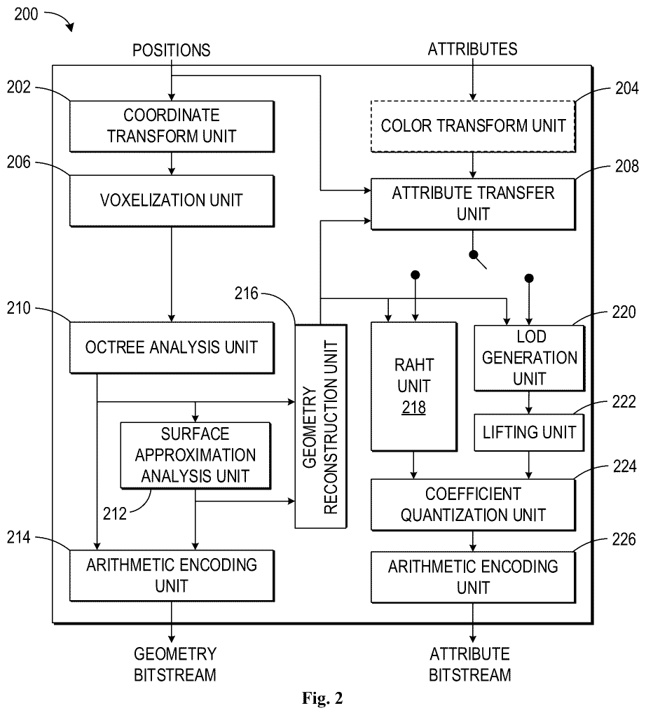

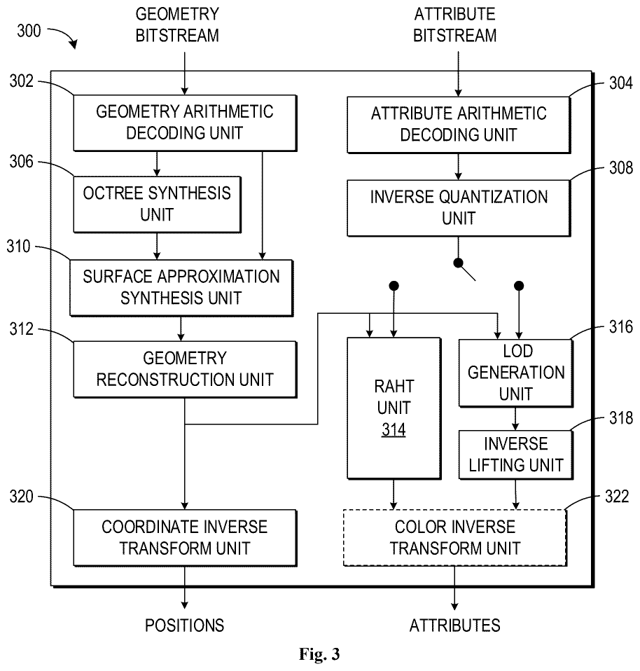

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively, or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream. Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is about the reference sample management in point cloud compression. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
CE Core Experiment
EE Exploration Experiment
PC Point Cloud.

### 3. Introduction

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions.

In one point cloud frame, there are many data points to describe the 3D objects or scenes. For each data point, there may be corresponding geometry information and attribute information. Geometry information is used to record the spatial location of the data point. Attribute information is used to record more details of the data point, such as texture, normal vector and reflection. In G-PCC, there are some tools designed to perform the compression of geometry information and attribute information respectively. For geometry information compression, there are three optional modes, octree mode, predictive tree mode and tri-soup mode. For attribute information compression, there are three optional modes, predict transform mode, lifting transform mode and region adaptive hierarchical transform (RAHT) mode. The encoding/decoding of geometry information and attribute information are performed serially. The encoding/decoding of attribute information is performed based on the reconstructed geometry information.

To explore the future point cloud coding technologies in G-PCC, Core Experiment (CE) 13.5 and Exploration Experiment (EE) 13.2 were formed to develop inter prediction technologies in G-PCC. Since then, many new inter prediction methods have been adopted by MPEG.

In current G-PCC, there are some kinds of hierarchical partition methods to divide each point cloud frame into one or multiple tiles and/or slices. A slice is the basic process unit to perform geometry and attribute encoding and decoding. Each slice is assigned with one slice id to indicate the slice in one frame. The slice id is determined at encoder and signalled to the decoder.

When the inter prediction is enabled for one point cloud sequence, there is at least one reference frame for each frame to perform inter prediction of geometry and attribute. The reference frame is used to provide the reference information of inter prediction for the current frame.

### 4. Problems

The existing designs for reference sample management have the following problems:
1. In current design, the whole reference frame is used as the reference point cloud of attribute inter prediction of one slice. However, most points in the reference frame are far from the space represented by the current slice. This wastes a lot of computing resources and may cause errors in the matching of reference information.
2. In current design, the reference frame of attribute inter prediction is updated with the reconstructed point cloud slice after the encoding/decoding of one slice. However, when there are multiple slices in one frame, the reference frame may be updated when only one slice of the frame is reconstructed. For example, the reference frame of the first slice of the current frame may be the last slice of the last frame. This may cause errors in the matching of reference information.

### 5. Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

In the following discussions, the term “PC sample” refer to the unit that performs prediction coding in the point cloud sequence coding, such as frame/picture/slice/tile/subpicture/node other units that contains one or more nodes or points.
1) It is proposed to update the reference frame after the encoding/decoding of the current frame is finished.
   a. In one example, the reference frame may be the reference point cloud for geometry inter prediction of one frame.
   b. In one example, the reference frame may be the reference point cloud for attribute inter prediction of one frame.
   c. In one example, the reference frame may be the reference point cloud(s) for geometry inter prediction and attribute inter prediction.
      i. In one example, there may be one reference point cloud for one reference frame, which is for both geometry inter prediction and attribute inter prediction.
      ii. In one example, there may be two reference point clouds for one reference frame, which are for geometry inter prediction and attribute inter prediction respectively.
         1. In one example, the reference point clouds for geometry inter prediction and attribute inter prediction may be represented in different geometry coordinate systems, such as Euclidean coordinate system, spherical coordinate system, polar coordinate system and so on.
         a. In one example, the geometry information of the reference frame for geometry inter prediction may be represented in a geometry coordinate system consistent with the original point cloud.
         b. In one example, the geometry information of the reference frame for attribute inter prediction may be represented in a geometry coordinate system converted from the geometry coordinate system of the original point cloud.
         2. In one example, the reference point clouds for geometry inter prediction and attribute inter prediction may be represented in the same geometry coordinate system, such as Euclidean coordinate system, spherical coordinate system, polar coordinate system and so on.
         3. In one example, the reference point clouds for geometry inter prediction and attribute inter prediction may be represented in different attribute spaces.
         4. In one example, the reference point clouds for geometry inter prediction and attribute inter prediction may be represented in the same attribute space.
   d. In one example, the reconstructed result of at least one PC sample may be used to update the reference frame of another frame.
      i. In one example, the reconstructed result of one PC sample may be used to update the reference frame of another frame, if there is only one PC sample in one frame.
   e. In one example, the reconstructed results of all PC samples of one frame may be used to update the reference frame of anther frame, if there are multiple PC samples in one frame.
      i. In one example, the reconstruction results of all PC samples may be merged to get the reconstructed frame and the reconstructed frame may be used to update the reference frame.
   f. In one example, the reference frame is updated only for being referred by the current frame.
   g. In one example, the reference frame updated by the current frame may be output for displaying with the samples after updating.
   h. In one example, the reference frame updated by the current frame may be output for displaying with the samples before updating.
   i. In one example, the reference frame updated by the current frame may be referred by another frame, with the samples after updating.
   j. In one example, the reference frame updated by the current frame may be referred by another frame, with the samples before updating.
   k. In one example, the reference frame updated by the current frame may be further updated by another frame.
2) It is proposed to derive the reference PC sample of the current PC sample before the inter prediction of the current PC sample.
   a. In one example, the reference PC sample may be the reference point cloud for inter prediction of the current PC sample.
   b. In one example, the reference PC sample may be derived from the reference frame of the frame, which the current PC sample belongs to.
3) It is proposed to derive the reference PC sample of one PC sample based on the geometry space information.
   a. In one example, the geometry space represented by the current PC sample may be derived.
      i. In one example, the geometry space represented by the current PC sample may be represented by the bounding box of the current PC sample.
         1. In one example, the bounding box may be represented by the ranges of the geometry information in each axis of the geometry coordinate system. For example, the ranges are represented by the minimum values and the maximum values.
      ii. In one example, the geometry space represented by the current PC sample may be represented by the expanding/shrinking bounding box of the current PC sample.
         1. In one example, the expanding bounding box may be represented by the expanding/shrinking ranges of the geometry information in each axis of the geometry coordinate system. For example, the ranges are represented by the minimum values−N and the maximum values+N, where N is the expanding/shrinking parameters.
         a. In one example, N may be pre-defined.
         b. In one example, N may be signalled to the decoder.
         i. In one example, N may be represented by one indication.
         ii. In one example, the indication may be coded with fixed-length coding, unary coding, truncated unary coding, etc. al.
         iii. In one example, the indication may be coded in a predictive way.
   b. In one example, the points in the reference frame which are in the geometry space represented by the current PC sample may be selected to be the reference PC sample.
   c. In one example, the PC sample in above description may be motion compensated.
   d. In one example, the reference frame in above description may be motion compensated.
4) It is proposed to derive the reference PC sample of one PC sample based on the PC sample indication.
   a. In one example, for each PC sample, there may be at least one indication to indicate the PC sample in the frame.
   b. In one example, for each reconstructed result that is used to be merged into the reference frame, there may be at least one indication to indicate the reconstructed result in the reference frame. The indication should be equal to the indication of the PC sample.
   c. In one example, the reconstructed result of each PC sample may be separated based on the indication.
   d. In one example, for each PC sample in the current frame, one reconstructed result in the reference frame may be used as the reference PC sample.
      i. In one example, the selected reconstructed result may be with the same indication with the current PC sample.
      ii. In one example, the selected reconstructed result may be with the nearest indication value with the indication value of the current PC sample.
      iii. In one example, the selected reconstructed result may be with the smallest geometry distortion with the current PC sample.
      iv. In one example, the selected reconstructed result may be with the smallest geometry distance with the current PC sample.
         1. In one example, the geometry distance may be the distance between two specific points in the reconstructed result and the PC sample, for example, the specific point may be the centroid.
   e. In one example, for each PC sample in the current frame, multiple reconstructed results in the reference frame may be used to derive the reference PC sample.
      i. In one example, the selected reconstructed results may be with the nearest indication values with the indication value of the current PC sample.
      ii. In one example, the selected reconstructed results may be with the smallest geometry distortions with the current PC sample.
      iii. In one example, the selected reconstructed results may be with the smallest geometry distances with the current PC sample.
         1. In one example, the geometry distance may be the distance between two specific points in the reconstructed result and the PC sample, for example, the specific point may be the centroid.
5) It is proposed to determine the method to derive the reference PC sample of one PC sample,
   a. In one example, there may be multiple methods to derive the reference PC sample of one PC sample.
   b. In one example, there may be at least one indication to indicate the method to derive the reference PC sample of one PC sample.
   c. In one example, the indication may be signalled to the decoder.
      i. In one example, the indication may be coded with fixed-length coding, unary coding, truncated unary coding, etc. al.
      ii. In one example, the indication may be coded in a predictive way.
   d. In one example, the indication may be derived at the decoder.
6) It is proposed to conditionally signal the attribute inter search range.
   a. In one example, the attribute inter search range may be used to perform the nearest neighbor search of attribute inter prediction in the level of details (LOD) based attribute coding.
   b. In one example, the attribute inter search range of each reference PC sample may be signalled to the decoder.
   c. In one example, the attribute inter search range of each reference frame may be signalled to the decoder.
   d. In one example, the attribute inter search range of the whole PC sequence may be signalled to the decoder.
      i. In one example, the attribute inter search range of each reference PC sample may be consistent in one PC sequence.
   e. In one example, the attribute inter search range may be signalled to the decoder when the LOD based attribute coding, such as predict transform mode in G-PCC, lifting transform mode in G-PCC, is used.
   f. In one example, the attribute inter search range may be not signalled to the decoder when the RAHT mode is used.
7) Whether to and/or how to apply a method disclosed above may be signaled from encoder to decoder in a bitstream/frame/tile/slice/octree/etc.
8) Whether to and/or how to apply the disclosed methods above may be dependent on coded information, such as dimensions, colour format, colour component, slice/picture type.

### 6. Embodiments

This embodiment describes an example of the designed method to update the reference frame when perform compression for one frame with one reference frame. FIG. 4 illustrates a flowchart 400 of the compression process of one frame with updating the reference frame.

As depicted, at block 410, a tile partition or a slice partition is applied to a current frame of a point cloud sequence. For example, a plurality of currnet slices may be partitioned from the current frame.

At block 420, a slice level compression is performed on the current slice(s) to obtained a reconstructed frame of the current frame. A reference frame may be used at block 420. The details of slice level compression and reconstructed frame generation are shown in the dashed box 420. For example, a bounding box detection may be performed for a slice in the reference frame to obtain a reference slice. A geometry compression is performed on a current slice to obtain geometry reconstructed slice. An attribute compression is performed based on the geometry reconstructed slice and the reference slice to obtain an attribute reconstructed slice. A reconstructed slice of the current slice is determined based on the attribute reconstructed slice and the geometry reconstructed slice. A plurality of reconstructed slices of a plurality of current slices in the current frame may be accumulated to obtain the reconstructed frame.

At block 430, the reference frame is updated based on the reconstructed frame.

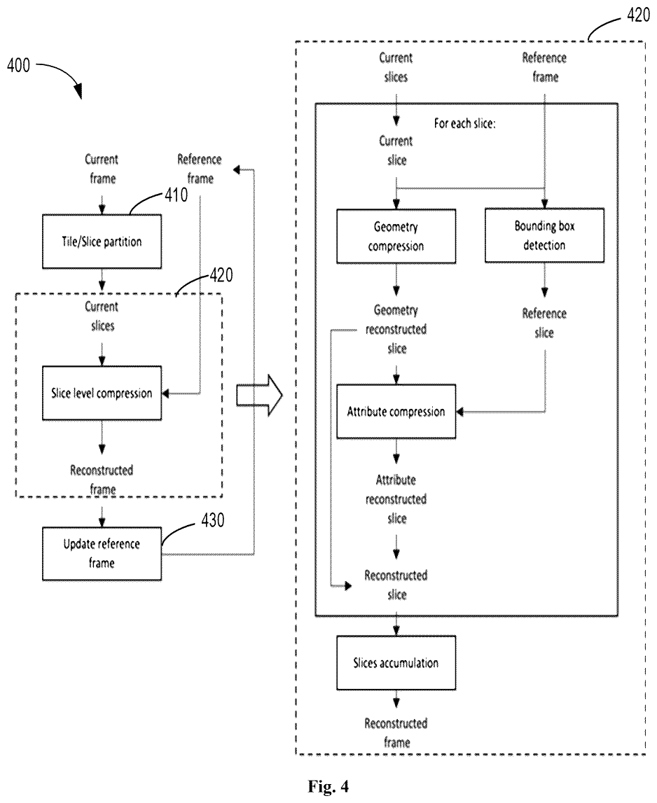

More details will be further discussed below. FIG. 5 illustrates a flowchart of a method 500 for point cloud coding in accordance with embodiments of the present disclosure.

At block 510, a conversion between a current frame of a point cloud sequence and a bitstream of the point cloud sequence is performed. In some embodiments, the conversion includes encoding the current frame into the bitstream. Alternatively, or in addition, in some embodiments, the conversion includes decoding the current frame from the bitstream. That is, the current frame may be encoded or decoded.

At block 520, a reference frame is updated based on the conversion. The reference frame is to be used for a further conversion between at least one subsequent frame of the point cloud sequence and the bitstream of the point cloud sequence. The reference frame may also be used for coding the current frame, or not used for the current frame.

The method 500 enables updating the reference frame which may be used for coding subsequent frame in the point cloud sequence. In this way, the coding effectiveness and coding efficiency can be improved.

In some embodiments, the reference frame comprises a reference point cloud for geometry inter prediction of a frame of the point cloud sequence.

In some embodiments, the reference frame comprises a reference point cloud for attribute inter prediction of a frame of the point cloud sequence.

In some embodiments, the reference frame comprises at least one reference point cloud for geometry inter prediction and attribute inter prediction of a frame of the point cloud sequence.

In some embodiments, the at least one reference point cloud comprises a single reference point cloud for both geometry inter prediction and attribute inter prediction.

In some embodiments, the at least one reference point cloud comprises a first reference point cloud for geometry inter prediction and a second reference point cloud for attribute inter prediction.

In some embodiments, the first and second reference point clouds are represented in different geometry coordinate systems, or wherein the first and second reference point clouds are represented in a same geometry coordinate system.

In some embodiments, a geometry coordinate system for a reference point cloud comprises one of: a Euclidean coordinate system, a spherical coordinate system, or a polar coordinate system.

In some embodiments, geometry information of the reference frame for geometry inter prediction is represented in a geometry coordinate system of an original point cloud in the point cloud sequence. As used herein, the term “original point cloud” refers to a point cloud whose coordinates are not converted to a geometry coordinate system from original geometry coordinates.

In some embodiments, geometry information of the reference frame for attribute inter prediction is represented in a geometry coordinate system converted from a further geometry coordinate system of an original point cloud in the point cloud sequence.

In some embodiments, the first and second reference point clouds are represented in different attribute spaces, or wherein the first and second reference point clouds are represented in a same attribute space.

In some embodiments, at least one reconstructed result of at least one point cloud (PC) sample of the current frame is used to update the reference frame of a further frame.

In some embodiments, a single PC sample is in the current frame, and the at least one reconstructed result of the single PC sample is used to update the reference frame.

In some embodiments, a plurality of point cloud (PC) samples is in the current frame, and reconstructed results of the plurality of PC samples are used to update the reference frame of a further frame.

In some embodiments, the reconstructed results of the plurality of PC samples are merged to obtain a reconstructed frame of the current frame, and the reference frame is updated based on the reconstructed frame.

In some embodiments, if the reference frame is referred by the current frame, the reference frame is updated.

In some embodiments, the reference frame updated based on the conversion associated with the current frame is output for displaying with samples after updating, or the reference frame updated based on the conversion associated with the current frame is output for displaying with samples before updating.

For example, the reference frame includes at least one updated sample and at least one unupdated sample.

The reference frame may be output for displaying with the at least one updated sample and/or the at least one unupdated sample.

In some embodiments, the reference frame is updated based on the current frame, and a further frame refers the reference frame with samples after updating, or the further frame refers the reference frame with samples before updating. For example, the reference frame includes at least one updated sample and at least one unupdated sample. The further frame may refer to the at least one updated sample and/or the at least one unupdated sample of the reference frame.

In some embodiments, information regarding whether to apply the method 500 and/or how to apply the method 500 is included in at least one of: the bitstream, a frame, a tile, a slice, or an octree.

In some embodiments, whether to and/or how to apply the method 500 is based on coded information, the coded information comprising at least one of: a dimension, a color format, a color component, a slice type or a picture type.

According to further embodiments of the present disclosure, a non-transitory computer-readable recording medium is provided. The non-transitory computer-readable recording medium stores a bitstream of a point cloud sequence which is generated by a method performed by a point cloud processing apparatus. The method comprises generating the bitstream based on a current frame of the point cloud sequence; and updating a reference frame based on the current frame, the reference frame to be used for at least one subsequent frame of the point cloud sequence.

According to still further embodiments of the present disclosure, a method for storing a bitstream of a point cloud sequence is provided. The method comprises: generating the bitstream based on a current frame of the point cloud sequence; updating a reference frame based on the current frame, the reference frame to be used for at least one subsequent frame of the point cloud sequence; and storing the bitstream in a non-transitory computer-readable recording medium.

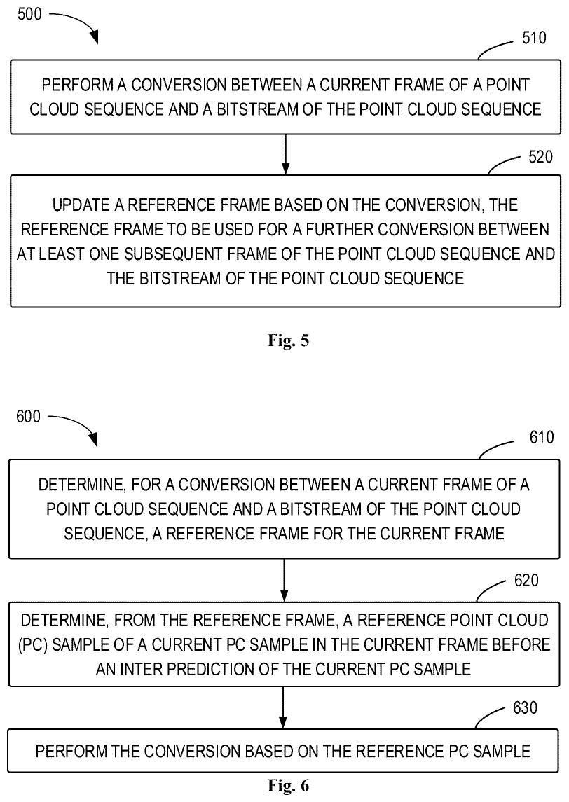

FIG. 6 illustrates a flowchart of a method 600 for point cloud coding in accordance with embodiments of the present disclosure. The method 600 is implemented for a conversion between a current frame of a point cloud sequence and a bitstream of the point cloud sequence.

At block 610, a reference frame for the current frame is determined. For example, the reference frame may be determined by updating as described with respect to FIG. 4 and FIG. 5.

At block 620, a reference point cloud (PC) sample of a current PC sample in the current frame is determined from the reference frame before an inter prediction of the current PC sample.

At block 630, the conversion is performed based on the reference PC sample. In some embodiments, the conversion includes encoding the current frame into the bitstream. Alternatively, or in addition, in some embodiments, the conversion includes decoding the current frame from the bitstream.

The method 600 enables determining a reference PC sample before an inter prediction of the current frame in the point cloud sequence. In this way, the coding effectiveness and coding efficiency can be improved.

In some embodiments, the reference PC sample comprises a reference point cloud for an inter prediction of the current PC sample.

In some embodiments, the reference PC sample is determined from a reference frame of the current frame, the current PC sample belonging to the current frame.

In some embodiments, determining the reference PC sample comprises: determining, from the reference frame, the reference PC sample based on geometry space information of the current frame before the inter prediction of the current PC sample.

In some embodiments, a geometry space represented by a current PC sample is determined, and the reference PC sample is determined based on the geometry space.

In some embodiments, the geometry space comprises a bounding box of the current PC sample, and the bounding box is represented by at least one range of geometry information in at least one axis of a geometry coordinate system, the at least one range comprising at least one minimum value and at least one maximum value of the geometry information in the at least one axis.

In some embodiments, the geometry space comprises a modified bounding box of the current PC sample, and the modified bounding box is represented by at least one modified range of geometry information in at least one axis of a geometry coordinate system, the at least one modified range being determined based on a parameter and at least one minimum value and at least one maximum value of the geometry information in the at least one axis.

In some embodiments, the modified bounding box comprises an expanding bounding box of the current PC sample, or a shrinking bounding box of the current PC sample.

In some embodiments, the parameter is pre-defined.

In some embodiments, the parameter is included in the bitstream. In some embodiments, the parameter is represented by an indication in the bitstream.

In some embodiments, the indication is coded with one of: a fixed-length coding, a unary coding, or a truncated unary coding, or wherein the indication is coded in a predictive manner.

In some embodiments, if a point in the reference frame is in the geometry space represented by the current PC sample, the point is selected to be included in the reference PC sample.

In some embodiments, a point cloud (PC) sample in the current frame is motion compensated.

In some embodiments, the reference frame is motion compensated.

In some embodiments, a reference point cloud (PC) sample of a PC sample in the current frame is determined based on at least one indication of the PC sample.

In some embodiments, for each PC sample, at least one indication indicates a corresponding PC sample in the current frame.

In some embodiments, for each reconstructed result to be merged into the reference frame, at least one indication indicates a corresponding reconstructed result in the reference frame, and the at least one indication of the reconstructed result being equal to at least one indication for PC sample.

In some embodiments, reconstructed results of a plurality of PC samples are separated based on indications of the plurality of PC samples.

In some embodiments, for each PC sample in the current frame, a reconstructed result in the reference frame is used as a reference PC sample.

In some embodiments, the reconstructed result is with a same indication with a current PC sample of the current frame.

In some embodiments, the reconstructed result is with a nearest indication value with a current PC sample of the current frame among a plurality of reconstructed results.

In some embodiments, the reconstructed result is with a smallest geometry distortion with a current PC sample of the current frame among a plurality of reconstructed results.

In some embodiments, the reconstructed result is with a smallest geometry distance with a current PC sample of the current frame among a plurality of reconstructed results, a geometry distance between the reconstructed result and the current PC sample comprising a distance between a point in the reconstructed result and a corresponding point in the current PC sample.

In some embodiments, the point comprises a centroid point.

In some embodiments, for each PC sample in the current frame, a plurality of reconstructed results in the reference frame is used to determine a reference PC sample.

In some embodiments, the plurality of reconstructed results is with a same indication with a current PC sample of the current frame.

In some embodiments, the plurality of reconstructed results is with at least one nearest indication value with a current PC sample of the current frame among a set of candidate reconstructed results.

In some embodiments, the plurality of reconstructed results is with at least one smallest geometry distortion with a current PC sample of the current frame among a set of candidate reconstructed results.

In some embodiments, the plurality of reconstructed results is with at least one smallest geometry distance with a current PC sample of the current frame among a set of candidate reconstructed results, a geometry distance between a reconstructed result and the current PC sample comprising a distance between a point in the reconstructed result and a corresponding point in the current PC sample.

In some embodiments, the point comprises a centroid point.

In some embodiments, at least one manner for determining a reference point cloud (PC) sample of a PC sample is determined.

In some embodiments, the at least one manner comprises a plurality of manners.

In some embodiments, at least one indication indicates the at least one manner for determining the reference PC sample.

In some embodiments, the at least one indication is included in the bitstream.

In some embodiments, the at least one indication is coded with one of: a fixed-length coding, a unary coding, or a truncated coding, or wherein the at least one indication is coded in a predictive manner.

In some embodiments, the at least one indication is determined at a decoder for decoding the current frame from the bitstream.

In some embodiments, information regarding whether to apply the method 600 and/or how to apply the method 600 is included in at least one of: the bitstream, a frame, a tile, a slice, or an octree.

In some embodiments, whether to and/or how to apply the method 600 is based on coded information, the coded information comprising at least one of: a dimension, a color format, a color component, a slice type or a picture type.

According to further embodiments of the present disclosure, a non-transitory computer-readable recording medium is provided. The non-transitory computer-readable recording medium stores a bitstream of a point cloud sequence which is generated by a method performed by a point cloud processing apparatus. The method comprises: determining a reference frame for a current frame of the point cloud sequence; determining, from the reference frame, a reference point cloud (PC) sample of a current PC sample in the current frame before an inter prediction of the current PC sample; and generating the bitstream based on the reference PC sample.

According to still further embodiments of the present disclosure, a method for storing a bitstream of a point cloud sequence is provided. The method comprises: determining a reference frame for a current frame of the point cloud sequence; determining, from the reference frame, a reference point cloud (PC) sample of a current PC sample in the current frame before an inter prediction of the current PC sample; generating the bitstream based on the reference PC sample; and storing the bitstream in a non-transitory computer-readable recording medium.

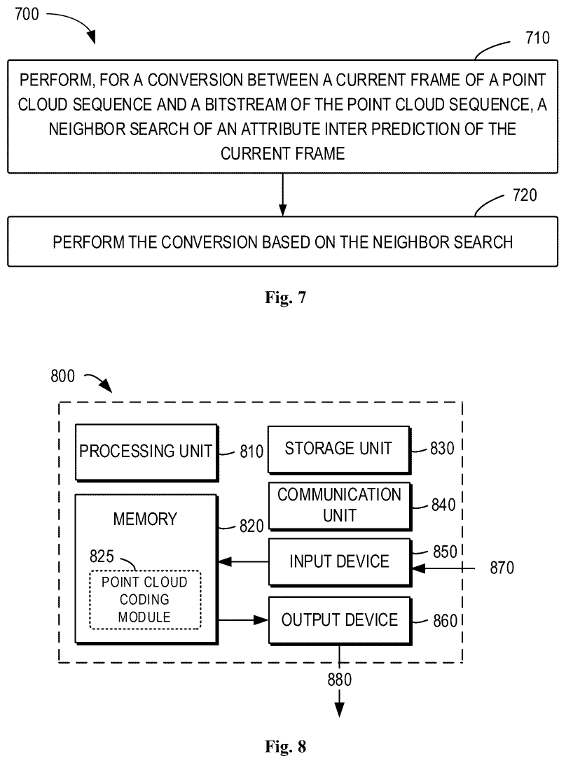

FIG. 7 illustrates a flowchart of a method 700 for point cloud coding in accordance with embodiments of the present disclosure. The method 700 is implemented for a conversion between a current frame of a point cloud sequence and a bitstream of the point cloud sequence.

At block 710, a neighbor search of an attribute inter prediction of the current frame is performed. An attribute inter search range for the neighbor search of the attribute inter prediction is included in the bitstream based on a condition.

At block 720, the conversion is performed based on the neighbor search. In some embodiments, the conversion includes encoding the current frame into the bitstream. Alternatively, or in addition, in some embodiments, the conversion includes decoding the current frame from the bitstream.

The method 700 enables indicating the attribute inter search range in the bitstream, which can improve the attribute coding.

In some embodiments, the neighbor search comprises a nearest neighbor search of the attribute inter prediction of the current frame in a level of details (LOD) based attribute coding.

In some embodiments, the attribute inter search range for each reference point cloud sample is included in the bitstream.

In some embodiments, the attribute inter search range for each reference frame is included in the bitstream.

In some embodiments, the attribute inter search range for the point cloud sequence is included in the bitstream.

In some embodiments, the attribute inter search range for a plurality of reference point cloud samples is consistent in the point cloud sequence.

In some embodiments, if the LOD based attribute coding is applied, the attribute inter search range is included in the bitstream.

In some embodiments, the LOD based attribute coding comprises at least one of: a predict transform mode in geometry based point cloud compression (G-PCC), or a lifting transform mode in G-PCC.

In some embodiments, if a region adaptive hierarchical transform (RAHT) mode is applied, the attribute inter search range is absent from the bitstream.

In some embodiments, information regarding whether to apply the method 700 and/or how to apply the method 700 is included in at least one of: the bitstream, a frame, a tile, a slice, or an octree.

In some embodiments, whether to and/or how to apply the method 700 is based on coded information, the coded information comprising at least one of: a dimension, a color format, a color component, a slice type or a picture type.

According to further embodiments of the present disclosure, a non-transitory computer-readable recording medium is provided. The non-transitory computer-readable recording medium stores a bitstream of a point cloud sequence which is generated by a method performed by a point cloud processing apparatus. The method comprises: performing a neighbor search of an attribute inter prediction of a current frame of the point cloud sequence; and generating the bitstream based on the neighbor search, wherein an attribute inter search range for the neighbor search of the attribute inter prediction is included in the bitstream based on a condition.

According to still further embodiments of the present disclosure, a method for storing a bitstream of a point cloud sequence is provided. The method comprises: performing a neighbor search of an attribute inter prediction of a current frame of the point cloud sequence; generating the bitstream based on the neighbor search; and storing the bitstream in a non-transitory computer-readable recording medium, wherein an attribute inter search range for the neighbor search of the attribute inter prediction is included in the bitstream based on a condition.

It is to be understood that the method 500, the method 600 and the method 700 can be applied separately, or in combination. The coding effectiveness and coding efficiency for point cloud coding can be improved with the method 500, the method 600 and/or the method 700.

Implementations of the present disclosure can be described in view of the following clauses, the features of which can be combined in any reasonable manner.
Clause 1. A method for point cloud coding, comprising: performing a conversion between a current frame of a point cloud sequence and a bitstream of the point cloud sequence; and updating a reference frame based on the conversion, the reference frame to be used for a further conversion between at least one subsequent frame of the point cloud sequence and the bitstream of the point cloud sequence.
Clause 2. The method of clause 1, wherein the reference frame comprises a reference point cloud for geometry inter prediction of a frame of the point cloud sequence.
Clause 3. The method of clause 1, wherein the reference frame comprises a reference point cloud for attribute inter prediction of a frame of the point cloud sequence.
Clause 4. The method of clause 1, wherein the reference frame comprises at least one reference point cloud for geometry inter prediction and attribute inter prediction of a frame of the point cloud sequence.
Clause 5. The method of clause 4, wherein the at least one reference point cloud comprises a single reference point cloud for both geometry inter prediction and attribute inter prediction.
Clause 6. The method of clause 4, wherein the at least one reference point cloud comprises a first reference point cloud for geometry inter prediction and a second reference point cloud for attribute inter prediction.
Clause 7. The method of clause 6, wherein the first and second reference point clouds are represented in different geometry coordinate systems, or wherein the first and second reference point clouds are represented in a same geometry coordinate system.
Clause 8. The method of clause 7, wherein a geometry coordinate system for a reference point cloud comprises one of: a Euclidean coordinate system, a spherical coordinate system, or a polar coordinate system.
Clause 9. The method of any of clauses 6-8, wherein geometry information of the reference frame for geometry inter prediction is represented in a geometry coordinate system of an original point cloud in the point cloud sequence.
Clause 10. The method of any of clauses 6-9, wherein geometry information of the reference frame for attribute inter prediction is represented in a geometry coordinate system converted from a further geometry coordinate system of an original point cloud in the point cloud sequence.
Clause 11. The method of any of clauses 6-10, wherein the first and second reference point clouds are represented in different attribute spaces, or wherein the first and second reference point clouds are represented in a same attribute space.
Clause 12. The method of any of clauses 1-11, wherein at least one reconstructed result of at least one point cloud (PC) sample of the current frame is used to update the reference frame of a further frame.
Clause 13. The method of clause 12, wherein a single PC sample is in the current frame, and the at least one reconstructed result of the single PC sample is used to update the reference frame.
Clause 14. The method of any of clauses 1-11, wherein a plurality of point cloud (PC) samples is in the current frame, and reconstructed results of the plurality of PC samples are used to update the reference frame of a further frame.
Clause 15. The method of clause 14, wherein the reconstructed results of the plurality of PC samples are merged to obtain a reconstructed frame of the current frame, and the reference frame is updated based on the reconstructed frame.
Clause 16. The method of any of clauses 1-15, wherein if the reference frame is referred by the current frame, the reference frame is updated.
Clause 17. The method of any of clauses 1-16, wherein the reference frame updated based on the conversion associated with the current frame is output for displaying with samples after updating, or wherein the reference frame updated based on the conversion associated with the current frame is output for displaying with samples before updating.
Clause 18. The method of any of clauses 1-17, wherein the reference frame is updated based on the current frame, and wherein a further frame refers the reference frame with samples after updating, or wherein the further frame refers the reference frame with samples before updating.
Clause 19. A method for point cloud coding, comprising: determining, for a conversion between a current frame of a point cloud sequence and a bitstream of the point cloud sequence, a reference frame for the current frame; determining, from the reference frame, a reference point cloud (PC) sample of a current PC sample in the current frame before an inter prediction of the current PC sample; and performing the conversion based on the reference PC sample.
Clause 20. The method of clause 19, wherein the reference PC sample comprises a reference point cloud for an inter prediction of the current PC sample.
Clause 21. The method of clause 19, wherein the reference PC sample is determined from a reference frame of the current frame, the current PC sample belonging to the current frame.
Clause 22. The method of any of clauses 19-21, wherein determining the reference PC sample comprises: determining, from the reference frame, the reference PC sample based on geometry space information of the current frame before the inter prediction of the current PC sample.
Clause 23. The method of clause 22, wherein a geometry space represented by a current PC sample is determined, and the reference PC sample is determined based on the geometry space.
Clause 24. The method of clause 23, wherein the geometry space comprises a bounding box of the current PC sample, and the bounding box is represented by at least one range of geometry information in at least one axis of a geometry coordinate system, the at least one range comprising at least one minimum value and at least one maximum value of the geometry information in the at least one axis.
Clause 25. The method of clause 23, wherein the geometry space comprises a modified bounding box of the current PC sample, and the modified bounding box is represented by at least one modified range of geometry information in at least one axis of a geometry coordinate system, the at least one modified range being determined based on a parameter and at least one minimum value and at least one maximum value of the geometry information in the at least one axis.
Clause 26. The method of clause 25, wherein the modified bounding box comprises an expanding bounding box of the current PC sample, or a shrinking bounding box of the current PC sample.
Clause 27. The method of clause 25 or 26, wherein the parameter is pre-defined.
Clause 28. The method of clause 25 or 26, wherein the parameter is included in the bitstream.
Clause 29. The method of clause 28, wherein the parameter is represented by an indication in the bitstream.
Clause 30. The method of clause 29, wherein the indication is coded with one of: a fixed-length coding, a unary coding, or a truncated unary coding, or wherein the indication is coded in a predictive manner.
Clause 31. The method of any of clauses 23-30, wherein if a point in the reference frame is in the geometry space represented by the current PC sample, the point is selected to be included in the reference PC sample.
Clause 32. The method of any of clauses 19-31, wherein a point cloud (PC) sample in the current frame is motion compensated.
Clause 33. The method of any of clauses 19-32, wherein the reference frame is motion compensated.
Clause 34. The method of any of clauses 19-33, wherein a reference point cloud (PC) sample of a PC sample in the current frame is determined based on at least one indication of the PC sample.
Clause 35. The method of clause 34, wherein for each PC sample, at least one indication indicates a corresponding PC sample in the current frame.
Clause 36. The method of clause 34 or 35, wherein for each reconstructed result to be merged into the reference frame, at least one indication indicates a corresponding reconstructed result in the reference frame, and the at least one indication of the reconstructed result being equal to at least one indication for PC sample.
Clause 37. The method of clause 34, wherein reconstructed results of a plurality of PC samples are separated based on indications of the plurality of PC samples.
Clause 38. The method of clause 34, wherein for each PC sample in the current frame, a reconstructed result in the reference frame is used as a reference PC sample.
Clause 39. The method of clause 38, wherein the reconstructed result is with a same indication with a current PC sample of the current frame.
Clause 40. The method of clause 38, wherein the reconstructed result is with a nearest indication value with a current PC sample of the current frame among a plurality of reconstructed results.
Clause 41. The method of clause 38, wherein the reconstructed result is with a smallest geometry distortion with a current PC sample of the current frame among a plurality of reconstructed results.
Clause 42. The method of clause 38, wherein the reconstructed result is with a smallest geometry distance with a current PC sample of the current frame among a plurality of reconstructed results, a geometry distance between the reconstructed result and the current PC sample comprising a distance between a point in the reconstructed result and a corresponding point in the current PC sample.
Clause 43. The method of clause 42, wherein the point comprises a centroid point.
Clause 44. The method of clause 34, wherein for each PC sample in the current frame, a plurality of reconstructed results in the reference frame is used to determine a reference PC sample.
Clause 45. The method of clause 44, wherein the plurality of reconstructed results is with a same indication with a current PC sample of the current frame.
Clause 46. The method of clause 44, wherein the plurality of reconstructed results is with at least one nearest indication value with a current PC sample of the current frame among a set of candidate reconstructed results.
Clause 47. The method of clause 44, wherein plurality of reconstructed results is with at least one smallest geometry distortion with a current PC sample of the current frame among a set of candidate reconstructed results.
Clause 48. The method of clause 44, wherein the plurality of reconstructed results is with at least one smallest geometry distance with a current PC sample of the current frame among a set of candidate reconstructed results, a geometry distance between a reconstructed result and the current PC sample comprising a distance between a point in the reconstructed result and a corresponding point in the current PC sample.
Clause 49. The method of clause 48, wherein the point comprises a centroid point.
Clause 50. The method of any of clauses 19-49, wherein at least one manner for determining a reference point cloud (PC) sample of a PC sample is determined.
Clause 51. The method of clause 50, wherein the at least one manner comprises a plurality of manners.
Clause 52. The method of clause 50 or 51, wherein at least one indication indicates the at least one manner for determining the reference PC sample.
Clause 53. The method of clause 52, wherein the at least one indication is included in the bitstream.
Clause 54. The method of clause 53, wherein the at least one indication is coded with one of: a fixed-length coding, a unary coding, or a truncated coding, or wherein the at least one indication is coded in a predictive manner.
Clause 55. The method of clause 52, wherein the at least one indication is determined at a decoder for decoding the current frame from the bitstream.
Clause 56. A method for point cloud coding, comprising: performing, for a conversion between a current frame of a point cloud sequence and a bitstream of the point cloud sequence, a neighbor search of an attribute inter prediction of the current frame; and performing the conversion based on the neighbor search, wherein an attribute inter search range for the neighbor search of the attribute inter prediction is included in the bitstream based on a condition.
Clause 57. The method of clause 56, wherein the neighbor search comprises a nearest neighbor search of the attribute inter prediction of the current frame in a level of details (LOD) based attribute coding.
Clause 58. The method of clause 56 or 57, wherein the attribute inter search range for each reference point cloud sample is included in the bitstream.
Clause 59. The method of clause 56 or 57, wherein the attribute inter search range for each reference frame is included in the bitstream.
Clause 60. The method of clause 56 or 57, wherein the attribute inter search range for the point cloud sequence is included in the bitstream.
Clause 61. The method of clause 60, wherein the attribute inter search range for a plurality of reference point cloud samples is consistent in the point cloud sequence.
Clause 62. The method of any of clauses 56-61, wherein if the LOD based attribute coding is applied, the attribute inter search range is included in the bitstream.
Clause 63. The method of clause 62, wherein the LOD based attribute coding comprises at least one of: a predict transform mode in geometry based point cloud compression (G-PCC), or a lifting transform mode in G-PCC.
Clause 64. The method of any of clauses 56-63, wherein if a region adaptive hierarchical transform (RAHT) mode is applied, the attribute inter search range is absent from the bitstream.
Clause 65. The method of any of clauses 1-64, wherein information regarding whether to apply the method and/or how to apply the method is included in at least one of: the bitstream, a frame, a tile, a slice, or an octree.
Clause 66. The method of any of clauses 1-64, wherein whether to and/or how to apply the method is based on coded information, the coded information comprising at least one of: a dimension, a color format, a color component, a slice type or a picture type.
Clause 67. The method of any of clauses 1-66, wherein the conversion includes encoding the current frame into the bitstream.
Clause 68. The method of any of clauses 1-66, wherein the conversion includes decoding the current frame from the bitstream.
Clause 69. An apparatus for point cloud coding comprising a processor and a non-transitory memory with instructions thereon, wherein the instructions upon execution by the processor, cause the processor to perform a method in accordance with any of clauses 1-68.
Clause 70. A non-transitory computer-readable storage medium storing instructions that cause a processor to perform a method in accordance with any of clauses 1-68.
Clause 71. A non-transitory computer-readable recording medium storing a bitstream of a point cloud sequence which is generated by a method performed by a point cloud processing apparatus, wherein the method comprises: generating the bitstream based on a current frame of the point cloud sequence; and updating a reference frame based on the current frame, the reference frame to be used for at least one subsequent frame of the point cloud sequence.
Clause 72. A method for storing a bitstream of a point cloud sequence, comprising: generating the bitstream based on a current frame of the point cloud sequence; updating a reference frame based on the current frame, the reference frame to be used for at least one subsequent frame of the point cloud sequence; and storing the bitstream in a non-transitory computer-readable recording medium.
Clause 73. A non-transitory computer-readable recording medium storing a bitstream of a point cloud sequence which is generated by a method performed by a point cloud processing apparatus, wherein the method comprises: determining a reference frame for a current frame of the point cloud sequence; determining, from the reference frame, a reference point cloud (PC) sample of a current PC sample in the current frame before an inter prediction of the current PC sample; and generating the bitstream based on the reference PC sample.
Clause 74. A method for storing a bitstream of a point cloud sequence, comprising: determining a reference frame for a current frame of the point cloud sequence; determining, from the reference frame, a reference point cloud (PC) sample of a current PC sample in the current frame before an inter prediction of the current PC sample; generating the bitstream based on the reference PC sample; and storing the bitstream in a non-transitory computer-readable recording medium.
Clause 75. A non-transitory computer-readable recording medium storing a bitstream of a point cloud sequence which is generated by a method performed by a point cloud processing apparatus, wherein the method comprises: performing a neighbor search of an attribute inter prediction of a current frame of the point cloud sequence; and generating the bitstream based on the neighbor search, wherein an attribute inter search range for the neighbor search of the attribute inter prediction is included in the bitstream based on a condition.
Clause 76. A method for storing a bitstream of a point cloud sequence, comprising: performing a neighbor search of an attribute inter prediction of a current frame of the point cloud sequence; generating the bitstream based on the neighbor search; and storing the bitstream in a non-transitory computer-readable recording medium, wherein an attribute inter search range for the neighbor search of the attribute inter prediction is included in the bitstream based on a condition.

### Example Device

FIG. 8 illustrates a block diagram of a computing device 800 in which various embodiments of the present disclosure can be implemented. The computing device 800 may be implemented as or included in the source device 110 (or the GPCC encoder 116 or 200) or the destination device 120 (or the GPCC decoder 126 or 300).

It would be appreciated that the computing device 800 shown in FIG. 8 is merely for purpose of illustration, without suggesting any limitation to the functions and scopes of the embodiments of the present disclosure in any manner.

As shown in FIG. 8, the computing device 800 includes a general-purpose computing device 800. The computing device 800 may at least comprise one or more processors or processing units 810, a memory 820, a storage unit 830, one or more communication units 840, one or more input devices 850, and one or more output devices 860.

In some embodiments, the computing device 800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 800 can support any type of interface to a user (such as “wearable” circuitry and the like).

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem and the like) enabling the computing device 800 to communicate with one or more other computing devices, if required. Such communication can be performed via input/output (I/O) interfaces (not shown).

In some embodiments, instead of being integrated in a single device, some or all components of the computing device 800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 800 may be used to implement point cloud encoding/decoding in embodiments of the present disclosure. The memory 820 may include one or more point cloud coding modules 825 having one or more program instructions. These modules are accessible and executable by the processing unit 810 to perform the functionalities of the various embodiments described herein.

In the example embodiments of performing point cloud encoding, the input device 850 may receive point cloud data as an input 870 to be encoded. The point cloud data may be processed, for example, by the point cloud coding module 825, to generate an encoded bitstream. The encoded bitstream may be provided via the output device 860 as an output 880.

In the example embodiments of performing point cloud decoding, the input device 850 may receive an encoded bitstream as the input 870. The encoded bitstream may be processed, for example, by the point cloud coding module 825, to generate decoded point cloud data. The decoded point cloud data may be provided via the output device 860 as the output 880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for point cloud coding, comprising:
performing a conversion between a current frame of a point cloud sequence and a bitstream of the point cloud sequence; and
updating a reference frame based on the conversion, the reference frame to be used for a further conversion between at least one subsequent frame of the point cloud sequence and the bitstream of the point cloud sequence.

2. The method of claim 1, wherein the reference frame comprises a reference point cloud for geometry inter prediction of a frame of the point cloud sequence.

3. The method of claim 1, wherein the reference frame comprises a reference point cloud for attribute inter prediction of a frame of the point cloud sequence.

4. The method of claim 1, wherein the reference frame comprises at least one reference point cloud for geometry inter prediction and attribute inter prediction of a frame of the point cloud sequence.

5. The method of claim 4, wherein the at least one reference point cloud comprises a single reference point cloud for both geometry inter prediction and attribute inter prediction.

6. The method of claim 4, wherein the at least one reference point cloud comprises a first reference point cloud for geometry inter prediction and a second reference point cloud for attribute inter prediction.

7. The method of claim 6, wherein the first and second reference point clouds are represented in different geometry coordinate systems, or
wherein the first and second reference point clouds are represented in a same geometry coordinate system.

8. The method of claim 7, wherein a geometry coordinate system for a reference point cloud comprises one of: a Euclidean coordinate system, a spherical coordinate system, or a polar coordinate system.

9. The method of claim 6, wherein geometry information of the reference frame for geometry inter prediction is represented in a geometry coordinate system of an original point cloud in the point cloud sequence.

10. The method of claim 6, wherein geometry information of the reference frame for attribute inter prediction is represented in a geometry coordinate system converted from a further geometry coordinate system of an original point cloud in the point cloud sequence.

11. The method of claim 1, wherein at least one reconstructed result of at least one point cloud (PC) sample of the current frame is used to update the reference frame of a further frame.

12. The method of claim 11, wherein a single PC sample is in the current frame, and the at least one reconstructed result of the single PC sample is used to update the reference frame.

13. The method of claim 1, wherein a plurality of point cloud (PC) samples is in the current frame, and reconstructed results of the plurality of PC samples are used to update the reference frame of a further frame.

14. The method of claim 13, wherein the reconstructed results of the plurality of PC samples are merged to obtain a reconstructed frame of the current frame, and the reference frame is updated based on the reconstructed frame.

15. The method of claim 1, wherein the conversion includes encoding the current frame into the bitstream.

16. The method of claim 1, wherein the conversion includes decoding the current frame from the bitstream.

17. An apparatus for point cloud coding comprising a processor and a non-transitory memory with instructions thereon, wherein the instructions upon execution by the processor, cause the processor to:
perform a conversion between a current frame of a point cloud sequence and a bitstream of the point cloud sequence; and
update a reference frame based on the conversion, the reference frame to be used for a further conversion between at least one subsequent frame of the point cloud sequence and the bitstream of the point cloud sequence.

18. The apparatus of claim 17, wherein the reference frame comprises a reference point cloud for geometry inter prediction of a frame of the point cloud sequence, or
wherein the reference frame comprises a reference point cloud for attribute inter prediction of a frame of the point cloud sequence, or
wherein the reference frame comprises at least one reference point cloud for geometry inter prediction and attribute inter prediction of a frame of the point cloud sequence.

19. A non-transitory computer-readable storage medium storing instructions that cause a processor to perform acts comprising:
performing a conversion between a current frame of a point cloud sequence and a bitstream of the point cloud sequence; and
updating a reference frame based on the conversion, the reference frame to be used for a further conversion between at least one subsequent frame of the point cloud sequence and the bitstream of the point cloud sequence.

20. A non-transitory computer-readable recording medium storing a bitstream of a point cloud sequence which is generated by a method performed by a point cloud processing apparatus, wherein the method comprises:
generating the bitstream based on a current frame of the point cloud sequence; and
updating a reference frame based on the current frame, the reference frame to be used for at least one subsequent frame of the point cloud sequence.
